(19) United States
(12) Patent Application Publication
(10) Pub. No.: US 2001/0021439 A1
(43) Pub. Date: Sep. 13, 2001

(54) Image receiving sheet and process for producing the same

(76) Inventors: Katsuhiko Sumita, Himeji-shi (JP); Masaya Omura, Himeji-shi (JP)

Correspondence Address: BIRCH STEWART KOLASCH & BIRCH, PO BOX 747, FALLS CHURCH, VA, 22040-0747, US

(21) Appl. No.: 09/754,377

(22) Filed: Jan. 5, 2001

(30) Foreign Application Priority Data
Jan. 7, 2000 (JP) 1687/2000
Feb. 17, 2000 (JP) 39981/2000

(51) Int. Cl. B32B 3/00

(52) U.S. Cl. 428/195; 428/196

(57) ABSTRACT

The imaging material of the present invention is an image-receiving sheet comprising at least a porous layer, which is fabricated by incorporating an organic acid having a solubility in 100 g of water at 20° C. of 0.01 to 2 g is incorporated into the porous layer. The imaging sheet may be constituted of a laminate of a substrate and a porous layer formed on at least one side of the substrate, or of a porous support. The organic acid may be an aromatic polycarboxylic acid, particularly an aromatic dicarboxylic acid. The image-receiving sheet of the present invention is excellent in ink absorption, blocking resistance, surface gloss, water resistance of recorded images, weatherability, visibility, and color reproducibility.

### FIELD OF THE INVENTION

The present invention relates to an image-receiving sheet suitable for ink jet recording, a process for producing the same, and a process for recording an image using the same.

### BACKGROUND OF THE INVENTION

Recently, for its being easily applicable to full-color image production, less noisy, excellent in print quality, and economical, the ink jet recording system has been popularized rapidly and adopted for office or home printers and wide printers for printing banners. The ink jet printing requires the use of an ink with a low drying rate for preventing an ink-injection nozzle from being clogged. In addition, from the standpoints of safety and suitability for recording, generally, predominantly employed is water-based ink. Droplets of ink are ejected from an injection nozzle head against a recording sheet, and therefore, it is essential that the sheet quickly absorbs the ink to record an image thereon.

For example, in the case of an image-receiving sheet which is poor in ink absorption, so that, even after recording, ink remains undried and unfixed and stays long on the surface of the ink receiving material, the recorded image is smeared with its own ink upon contact with a feed roller of a recorder or an operator or when other sheets are put thereon. Moreover, in high-density image areas, the inks supplied in large amounts are not absorbed and mixed together, resulting in deterioration in the quality of the recorded image or characters or the inks flowing down the surface of the image receiving material.

For solving these problems in the prior art, there have been made some proposals. For example, Japanese Patent Application Laid-Open No. 174381/1984 (JP-59-174381A) and Japanese Patent Application Laid-Open No. 224578/1985 (JP-60-224578A) propose forming an ink-receiving layer on a support using a hydrophilic polymer such as starch, a water-soluble cellulose derivative, and polyvinyl alcohol. Although this image receiving sheet is satisfactory in ink absorption, the water-resistance of the ink-receiving layer itself is poor, and therefore, the ink-receiving layer or the recorded areas dissolve in water or the surface of the material becomes viscous, resulting in blocking of the sheets upon stacking.

Moreover, Japanese Patent Publication No. 72460/1991 (JP-3-72460B) proposes a process for improving the blocking resistance, wherein a sheet is constituted of an ink-permeable surface layer and an ink-absorbent underlayer. The underlayer absorbs ink, keeping the surface of the sheet free from blocking. However, since the ink permeates through the surface layer and is absorbed by the underlayer, such infiltration of the ink deep into the recording sheet not only makes it hard to deepen the colors at the recorded areas but causes the surface layer and the underlayer to split at the interface easily. In addition, the water resistance of the underlayer is also poor.

There has also been proposed to provide a porous layer as an ink-absorbing layer and allows it to absorb ink utilizing the capillary phenomenon. For example, Japanese Patent Application Laid-Open No. 110287/1983 (JP-58-110287A) and Japanese Patent Application Laid-Open No. 51470/1993 (JP-5-51470A) propose recording sheets constituted of a support and a porous layer formed thereon, the porous layer being the aggregate of fine particles of, for example, silica with the gaps between the particles as its pores. These recording sheets were improved in ink absorption, yet they are poor in transparency or surface gloss due to the scattering of light by the particles. Therefore, these sheets are not suitable as OHP (overhead projector) sheets required of transparency or for use in high-quality image printing such as photography requiring the recording material to have a highly gloss surface. Moreover, their ink absorption capacity is also insufficient. Japanese Patent Application Laid-Open No. 278417/1998 (JP-10-278417A) proposed a recording sheet in which a porous layer is provided on an ink-absorbing layer formed on a support, but this sheet is also unsatisfactory for use in high-quality image printing.

Further, Japanese Patent Application Laid-Open No. 233569/2000 (JP-2000-233569A) discloses a recording sheet comprised of a porous film having a three-dimensional network structure constituted of granular parts and thread-like connecting parts joined thereto, and that a water-soluble polycarboxylic acid such as maleic acid is incorporated into the porous film and/or an ink absorbing layer, yet the image definition or sharpness of this recording sheet is still insufficient.

Japanese patent Application Laid-Open No. 86251/1986 (JP-61-86251A) proposes a recording sheet composed of an ink-absorbing layer laminated with a porous plastic thin layer. So that the porous plastic thin layer is made of a hydrophobic plastic such as polyethylene and polypropylene, the ink permeability of this recording sheet is insufficient for use in ink jet printing in which an water-based ink is generally employed. In addition to this, since the porous plastic thin layer is laminated on the ink absorbing layer by thermocompresssion bonding, its pores could be crushed or deformed.

On the other hand, in the case of ink jet-printing an image on cloth such as fabrics, conventionally, an image is ink jet-printed on the surface of cloth provided with the above-described ink absorbing layer. Alternatively, after an image has been printed on an ink absorbing layer, containing a hot-melt adhesive resin, of a recording sheet, the layer is thermally transferred to cloth. These techniques, however, have the problem that the ink-absorbing layer spoils the texture of the cloth.

### SUMMARY OF THE INVENTION

Thus, an object of the present invention is to provide an image-receiving sheet which is excellent in ink absorption and blocking resistance and has significantly improved surface gloss, sharpness and color reproducibility of recorded images, and a process for producing the same.

Another object of the present invention is to provide an image-receiving sheet excellent not only in ink absorption and blocking resistance but also in texture, and a process for producing the same.

A still further object of the present invention is to provide an image-receiving sheet which yields an image excellent in water resistance and weatherability, and a process for producing the same.

Still another object of the present invention is to provide an image-receiving sheet having a suitable adhesion strength between an ink-receiving layer and a substrate, and excellent delamination properties, and a process for producing the same.

Yet another object of the present invention is to provide a method for forming an image to be recorded with significantly improved sharpness and color reproducibility.

The inventors of the present invention made intensive and extensive studies to achieve the above-mentioned objects and finally found that incorporation of a specific organic acid into a porous layer of an image-receiving sheet constituted of the porous layer largely improves not only the ink absorption and blocking resistance of the imaging material but also surface gloss and sharpness of recorded images. The present invention was accomplished based on the above findings.

That is, the image-receiving sheet of the present invention comprises at least a porous layer containing an organic acid having a solubility in 100 g of water at 20° C. of 0.01 to 2 g. The image-receiving sheet may be a laminate composed of a substrate and a porous layer provided on at least one side of the substrate, or may be constituted of a porous support. As the organic acid, an aromatic polycarboxylic acid, particularly, an aromatic dicarboxylic acid is preferred. The mean pore size of the porous layer is about 0.005 to 10 μm. The image receiving sheet may have a porous layer made of a hydrophilic polymer (particularly, a cellulose derivative, a vinyl-series polymer, and a polysulfone-series polymer) on at least one side of the substrate. In the case where the porous layer contains the organic acid, the proportion of the acid is, relative to 100 parts by weight of the hydrophilic polymer, about 1 to 100 parts by weight, preferably about 2 to 100 parts by weight. The porous layer may be separable from the substrate, and the adhesion strength between the porous layer and the substrate may be about 1 to 500 g/15 mm. The image-receiving sheet after printing may satisfy the following formula (1):

|Fp−Fn|<150 g/15 mm

wherein Fn is the adhesion strength between the porous layer and the substrate in the non-imaged area and Fp is that in the imaged area.

The image-receiving sheet described above may be one composed of a porous support which itself serves as the porous layer, to at least one side of which may be applied the organic acid. The amount of the organic acid applied thereto is, on a dried matter basis, usually about 0.05 g/m² or more, preferably about 0.05 to 1 g/m². The porous support may be a porous plastic sheet, a fabric (e.g., woven-fabric, non-woven fabric).

The present invention includes a process for producing an image-receiving sheet comprising at least a porous layer, wherein an organic acid having a solubility in 100 g of water at 20° C. of 0.01 to 2 g is incorporated into the porous layer of an image-receiving sheet. In the production process, the porous layer may be formed by coating a dope containing a hydrophilic polymer, good and poor solvents for the hydrophilic polymer, and the above-mentioned organic acid on at least one side of a substrate sheet, and then subjecting the resulting coat to phase conversion. Alternatively, the process comprises forming the porous layer by coating of a dope containing a hydrophilic polymer and good and poor solvents for the hydrophilic polymer on at least one side of a substrate sheet, subjecting the resulting coat to phase conversion, coating the phase-converted with a coating agent containing the above-mentioned organic acid, and removing a solvent of the coating agent. Further, the organic acid having such solubility as described above may be applied (by coating or immersion) to at least one side of the porous support.

The present invention also includes a process for forming an image to be recorded in which the image (particularly, an image printed in water-based ink) is recorded on the porous layer of the image-receiving sheet (an imaging material in which a porous layer is formed on at least one side of a substrate) and then the porous layer is separated from the substrate, and a process in which an image is recorded on the porous layer of the above-described image-receiving sheet, a cover sheet is laminated on the porous layer, and the cover sheet and the porous layer are separated or delaminated from the substrate.

### DETAILED DESCRIPTION OF THE INVENTION

The image-receiving sheet of the present invention need only comprise at least a porous layer. For example, the image-receiving sheet of the present invention may be a laminate comprising a substrate and a porous layer provided on at least one side of the substrate, or may be constituted of a porous support.

[Substrate of the Laminate]

There is no particular restriction as to the material of the substrate. Examples of the substrate include paper, coated paper, synthetic paper, non-woven cloth, and plastic films or sheets, albeit preferably used as the substrate is paper, coated paper, or a plastic film or sheet from the viewpoints of strength and practicality.

Examples of paper and coated paper are wood free paper, Kent Paper, and art paper.

Exemplified as the polymer constituting the synthetic paper or the plastic film or sheet are olefinic polymers (e.g., polypropylene), halogen-containing polymers (e.g., polyvinyl chloride), styrenic resins (e.g., polystyrene, rubber-reinforced polystyrene, ABS resin), cellulose-series resins (cellulose derivatives) (e.g., cellulose acetate), polyester-series resins (e.g., polyethylene terephthalate, polybutylene terephthalate, polyethylene naphthalate, polybutylene naphthalate), polycarbonate-series resins (e.g., bisphenol A-based polycarbonate), and polyamide-series resins (e.g., aliphatic polyamides such as nylon 6). Copolymers, blends, and crosslinked products of these also can be used. Of these, from the viewpoints of, for example, mechanical strength and workability, polyester-series resins, particularly polyalkylene arylate-series resins such as polyethylene terephthalate are preferably employed. These resins can be used either singly or in combination, and in the form of a single-layered film or a laminated film as well.

If necessary, to the plastic film or sheet may be added an antioxidant, a heat stabilizer, a lubricant, a pigment, an ultraviolet ray absorber, and others. Moreover, for improving the adhesion with the porous layer, the substrate may be subjected to corona discharge treatment or undercoat treatment.

Considering that the production of an image usually involves the insertion of the resulting recording material into an ink jet printer, the thickness of the substrate should be, for example, about 20 to 200 μm, preferably about 50 to 170 μm, and more preferably about 80 to 150 μm.

[Porous layer of the Laminate]

There is no particular restriction as to the polymer forming the porous layer provided that the resulting porous layer shows high wettability toward ink, and a variety of resins (thermoplastic resins, thermosetting resins) can be used. Usually, a thermoplastic resin is employed. As the thermoplastic resin, the following resins or polymers are exemplified.

(1) Cellulose-Series Resin (cellulose derivative)

Cellulose Esters [e.g., organic acid esters such as cellulose acetate, cellulose propionate, cellulose butylate, cellulose acetate propionate, and cellulose acetate butylate; inorganic acid esters such as cellulose nitrate, cellulose sulfate, and cellulose phosphate; mixed acid esters such as cellulose nitrate acetate].

Cellulose ethers [e.g., methylcellulose, ethylcellulose, isopropylcellulose, butylcellulose, benzylcellulose, hydroxyethylcellulose, carboxymethylcelullose, carboxyethylcellulose, cyanoethylcelluose].

(2) Vinyl-series Polymers

Olefinic polymers [e.g., homo- or copolymers of olefines (e.g., polyethylene, polypropylene, poly-1-butene, polyisobutene, polybutadiene, polyisoprene, polyallene, ethylene-propylene copolymer), copolymers of olefines with copolymerizable monomers (e.g., ethyl-ene-vinyl acetate copolymer, ethylene-(meth)acrylic acid ester copolymer, modified polyolefines)].

Halogen-containing vinyl polymers [e.g., homo- or copolymers of halogen-containing vinyl monomers (e.g., polyvinyl chloride), copolymers of halogen-containing vinyl monomers with copolymerizable monomers (e.g., vinyl chloride-vinyl acetate copolymer, vinylidene chloride-vinyl acetate copolymer, vinylidene chloride-(meth)acrylic acid copolymer, vinylidene chloride-(meth)acrylic acid ester copolymer)].

Vinyl ester-series polymers and derivatives thereof [e.g., polyvinyl acetate, polyvinyl alcohol, ethylene-vinyl alcohol copolymer, polyvinyl acetal-series polymers (e.g., polyvinyl formal, polyvinyl acetal, polyvinyl butyral)].

Heterocyclic vinyl-series polymers [e.g., polyvinylpyrrolidone, polyvinylpyridine].

Aromatic vinyl-series polymers [e.g., styrenic polymers (e.g., polystyrene, rubber-reinforced polystyrene, ABS resin), copolymers of aromatic vinyl monomers with copolymerizable monomers (e.g., styrene-C₁₋₁₀alkyl methacrylate copolymers, styrene-malic anhydride copolymer, styrene-maleimide copolymer)].

Allyl alcohol-series polymers (e.g., allyl alcohol-C₁₋₆ alkyl vinyl ether copolymers) Polyvinyl ketones [e.g., polyvinyl methyl ketone, polyvinyl methyl isobutyl ketone, polymethyl isopropenyl ketone].

Vinyl ether-series polymers [e.g., polymethyl vinyl ether, methyl vinyl ether-maleic anhydride copolymer].

(Meth)acrylic polymers [e.g., homo- or copolymers of (meth)acrylic monomers (e.g., (meth)acrylonitrile, (meth)acrylate monomers), copolymers of (meth)acrylic monomers with copolymerizable monomers (vinyl-series monomers such as vinyl ester-series monomers, heterocyclic vinyl-series monomers such as vinylpyrrolidone, aromatic vinyl monomers, polymerizable unsaturated dicarboxylic acids and derivatives thereof)].

(3) Polysulfone-Series Polymers

Polysulfones (e.g., polyhexamethylenesulfone), sulfonated polysulfone, polyether sulfone, polymers having the bonding group —SO₂— within their molecules.

(4) Polyester-series polymers

Polyalkylene terephthalates (e.g., homo- or co-polyesters containing 1,4-cyclohexanedimethylene terephthalate, ethylene terephthalate, or butylene terephthalate), polyalkylene naphthalates (e.g., homo- or copolyesters containing ethylene naphthalate or butylene naphthalate), and others.

(5) Polyamide-Series Polymers

Aliphatic polyamides (e.g., nylon 6, nylon 66, nylon 610, nylon 612, nylon 11, nylon 12).

(6) Polycarbonate-Series Polymers

Polymers obtainable through the reaction between a dihydroxy compound such as 2,2-bis(4-hydroxyphenyl)propane (bisphenol A) and phosgene or a carbonic diester such as diemethyl carbonate.

(7) Polyurethane-Series Polymers

Polymers obtainable through the reaction between a polyisocyanate such as tolylene diisocyanate with polyol such as polyethylene glycol.

(8) Polymers Derived from Epoxides

Polyalkylene glycols (e.g., polyethylene glycol, polypropylene glycol) and epoxy resins (e.g., ether-series epoxy resins such as bisphenol-based epoxy resins and novolak-series epoxy resins, amine-series epoxy resins).

These polymers can be used either singly or in combination.

There is no particular restriction as to the polymer constituting the porous layer provided that the wettability of the surface of the layer or pores toward ink is high, and the polymer is suitably selected according to the type of the ink to be used. Inks generally employed are water-based ones. In such cases, of the polymers listed above, hydrophilic polymers are particularly preferred. Incidentally, polymers the term “hydrophilic polymer” refers to are those having a contact angle to water of smaller than 80° (preferably about 0 to 60°, particularly about 0 to 40°). Assuming a water drop is placed on the surface of the polymer at room temperatures, the contact angle refers to the water drop-side one of the angles divided by the tangential line drawn along the surface of the water drop at the point where the water drop stopped spreading, to the intersection of the polymer surface.

Examples of such hydrophilic polymers are cellulose derivatives [e.g., cellulose esters such as cellulose acetates (e.g., cellulose diacetate, cellulose triacetate), cellulose propionate, and cellulose nitrate; cellulose ethers such as ethyl cellulose], vinyl-series polymers [e.g., (meth)acrylic polymers poly(meth)acrylates such as polymethyl methacrylate, polyacrylonitrile, acrylonitrile-vinylpyrrolidone co-polymers (e.g., copolymers with an acrylonitrile content of about 50 to 99.9 mol %), polyacrylamide, poly-N-methylacrylamide), polyvinylpyrrolidone, vinyl ether-series polymers (e.g., polymethyl vinyl ether, methyl vinyl ether-maleic anhydride copolymer), vinyl acetate-series polymers and derivatives thereof (e.g., polyvinyl acetate and its partially saponified products, polyvinyl alcohol, ethylene-vinyl acetate copolymer and its partially saponified products), polysulfone-series polymers (e.g., polysulfone, polyether sulfone), polyethylene glycol, polyethylene imine, polyamide, and styrene-maleic anhydride copolymer. Of these, cellulose derivatives, vinyl-series polymers, and polysulfone-series polymers are particularly preferred.

Although polytetrafluoroethylene, polyethylene, and polystyrene are hydrophobic according to the definition mentioned above, these can be included in the polymers considered to be hydrophilic in the present invention, by making the surface thereof hydrophilic through addition or coating of, for example, a surfactant or a wetting agent, or plasma treatment.

The porous layer may have separability or peelability for making the separation of the porous layer from the substrate easier. Moreover, to the porous layer may be added a mold-releasing agent for improving its separability or peelability.

As the mold-releasing agent, there may be exemplified silicone-series compounds (e.g., silicone oil, silicone resin, polyorganosiloxane having a polyoxyalkylene unit), higher fatty acids and salts thereof, higher fatty acid esters, wax (e.g., vegetable wax such as carnauba wax, animal wax such as lanolin, paraffin such as paraffin wax, polyethylene wax), and fluorine-containing compounds (e.g., fluorine oil, polytetrafluoroethylene). These mold-releasing agents can be used in the form of emulsions and either singly or in combination.

The amount of the mold-releasing agent to be used is, relative to 100 parts by weight of polymer constituting the porous layer, for example about 0.01 to 10 parts by weight, preferably about 0.1 to 5 parts by weight (e.g., 0.1 to 2) on a solid matter basis.

Into the porous layer may be incorporated fine particles thereby to improve its separability. Examples of the powder are inorganic powders (e.g., mineral powders such as white carbon, calcium silicate, aluminum silicate, magnesium silicate, zeolite, magnesium aminosilicate, diatomaceous earth, calcined diatomaceous earth, magnesium carbonate, alumina, silica, talc, kaolin, delaminated kaolin, clay, zinc oxide, heavy calcium carbonate, light calcium carbonate, magnesium carbonate, titanium dioxide, aluminium hydroxide, calcium hydroxide, magnesium hydroxide, calcium sulfate, barium sulfate, sericite, bentonite, and smectite) and organic powders (e.g., crosslinked or non-crosslinked organic powders or finely divided hollow particles of polystyrene resin, acrylic resin, urea resin, melamine resin, and benzoguanamine resin). These powders can be used either singly or in combination. The mean particle size of the powder is about 1 to 30 μm, preferably about 2 to 25 μm (e.g., 2 to 20 μm), usually 5 to 25 μm (e.g., 10 to 25 μm).

The amount of the fine particles to be used is, for example, about 0.05 to 10 parts by weight, preferably about 0.1 to 5 parts by weight, and more preferably about 0.15 to 3 parts by weight on a solid matter basis relative to 100 parts by weight of the polymer constituting the porous layer.

In the present invention, the porous layer is separable from the substrate. According to the intended use, the adhesion strength between the porous layer and the substrate is suitably selected within the range of about 1 to 500 g/15 mm (e.g., 2 to 500 g/15 mm), preferably about 1 to 200 g/15 mm (e.g., 7 to 200 g/15 mm), more preferably about 2 to 150 g/15 mm (e.g., 2 to 140 g/15 mm), usually about 3 to 100 g/15 mm (e.g., 10 to 60 g/15 mm).

In the present invention, the image-receiving sheet after image forming may satisfy the following formula (1), preferably the formula (2), more preferably the formula (3). In the formula, the adhesion strength between the porous layer and the substrate in the non-imaged area is denoted by Fn, and that in the imaged area by Fp. The conditions under which images are printed are the same as those in the ink absorption testing in Examples that will later be described.

|Fp−Fn|<150 g/15 mm (1)

|Fp−Fn|<120 g/15 mm (2)

|Fp−Fn|<90 g/15 mm (3)

The average size of the pores at the surface of and inside the porous layer can be selected within the range of about 0.005 to 10 μm, preferably about 0.01 to 8 μm, and more preferably about 0.01 to 5 μm (e.g., 0.01 to 3 μm). A mean pore size of smaller than 0.005 μm may lead to insufficient ink absorption, while a mean pore size exceeding 10 μm tends to cause degradation of water-resistance or print quality.

The degree of porosity also exerts influence on the ink absorptivity of the porous layer. The porosity of the porous layer can be selected within the range of about 40 to 80%, preferably about 42% to 75%. If the porosity is lower than 40%, the ink absorbing capability of the layer would be worse. If the porosity exceeds 80%, the strength of the porous layer itself would be weaker.

There is no specific restriction as to the thickness of the porous layer and it is selected according to the intended use. The thickness is selected within the range of, for example, about 1-to 100 μm, preferably about 3 to 50 μm (e.g., 5to 30 μm). If the thickness of the porous layer is less than 1 μm, its water resistance would be unsatisfactory. If the thickness of the porous layer exceeds 100 μm, its transparency, ink absorptivity, or other properties would be deteriorated.

The porous layer may further contain a variety of conventional additives such as crosslinking agents, curing agents, antifoams, coatability improving agents, thickeners, lubricants, stabilizers (e.g., antioxidants, ultraviolet ray absorbers, heat stabilizers, light-resistant stabilizers), dyes, pigments, antistatic agents, antiblocking agents, fillers, gelling agents, and others.

[Porous support]

There is no particular restriction as to the porous support. Examples of the porous support are porous plastic sheets and fibrous supports.

There is no particular restriction as to the polymer constituting the porous plastic sheet provided that it shows high wettability toward ink, and a variety of resins (thermoplastic and thermosetting resins) can be used. Usually, a thermoplastic resin is employed. Exemplified as the thermoplastic resin are those enumerated in the paragraphs referring to the porous layer, such as the polyester-series polymers, vinyl-series polymers, cellulose-series polymers (cellulose derivatives), polycarbonate-series polymers, polyamide-series polymers, polysulfone-series polymers, polyurethane-series polymers, and polymers derived from the epoxides.

Copolymers, blends, and crosslinked products thereof can also be used. Of these, for the porous support, polyester-series polymers, particularly polyalkylenearylate-series polymers such as polyethylene terephthalate are preferably employed from viewpoints of mechanical strength and workability. These polymers can be used either singly or in combination, and these can be used in the form of a single-layered or laminated sheet as well.

The porous plastic sheet can be fabricated by a phase separation process in which a polymer is micro-phase-separated using good and poor solvents, a foaming process in which a polymer is foamed to form pores, a stretching process in which a polymer film is stretched, a radiation process in which a polymer film is exposed to radiation thereby to make pores, an extraction process in which from a film made from a polymer or inorganic salt soluble in a solvent and a polymer insoluble in the solvent is extracted the component soluble in the solvent to make pores, a sintering process in which polymer particles are partially fused or fixed with a binder to utilize the gaps between the particles as pores, or by other processes.

Examples of the fibrous support are cloth (woven cloth or non-woven cloth) and paper. The fibrous support has a conformation where fibers are randomly or orderly entangled. Paper or non-woven cloth usually has a web structure.

Insofar as ink absorption is not adversely affected, there is no specific restriction as to the kind (the kind of the material) of the woven or non-woven cloth, and the woven or non-woven cloth can be fabricated from fibers (e.g., natural fiber, regenerated fiber, semi-synthesized fiber, synthetic fiber) in accordance with a conventional process (e.g., in the case of non-woven cloth, by a process in which fibers are webbed and thermocompression-bonded or bonded using an adhesive, or the needle punching process).

Examples of the natural fiber are cotton, hemp, silk, wool, cellulose fibers. Exemplified as the regenerated fiber is rayon (e.g., viscous rayon). Examples of the semi-synthetic fiber are cellulose ester-series fibers (e.g., cellulose acetate fiber) and cellulose ether-series fibers (e.g., methyl cellulose fiber). Examples of the synthetic fiber are thermoplastic resins such as polyester (e.g., polyethylene terephthalate, polybutylene terephthalate), (meth)acrylic resins (e.g., poly(meth)acrylates, polyacrilonitrile), polycarbonate, polyether, polyether esters, polyamides (e.g., nylon 6, nylon 66), polyimide, polyamideimide, polyolefines (e.g., polyethylene, polypropylene), halogen-containing vinyl resins (e.g., polyvinyl chloride, polyvinylidene chloride), and polystyrene; and those obtainable from copolymers being combinations of constitutive units of these resins, their crosslinked products, and from their mixtures. Preferred fibers are cellulose ester fibers (e.g., cellulose acetate), polyester fibers (e.g., polyethylene terephthalate fiber, polybutylene terephthalate fiber), polyolefine fibers (e.g., polyethylene fiber, polypropylene fiber), and polyamide fiber. Polyester fiber is particularly preferred.

The “metsuke” (density) of the woven or non-woven cloth is, for example, about 50 g/m or higher, preferably about 100 g/m² (e.g., 100 to 1,000 g/m², more preferably about 200 to 800 g/m². The average fiber diameter is, for example, about 0.01 to 100 μm, preferably about 0.1 to 50 μm (particularly, 1 to 10 μm). The degree of air permeability is about 0.1 to 100 cm³/cm²·s, preferably about 0.1 to 50 cm³/cm²·s.

Examples of the paper are coated paper (e.g., wood free paper, Kent paper, art paper) and synthetic paper.

The average size of the pores at the surface of or inside the porous support can be selected within the range of about 0.005 to 10 μm, preferably 0.01 to 8 μm, more preferably about 0.01 to 5 μm (e.g., 0.01 to 3 μm). A mean pore size of smaller than 0.005 μm may lead to insufficient ink absorption, while a mean pore size exceeding 10 μm tends to cause degradation of water resistance or print quality.

The porosity of the porous support also exerts influence on its ink absorption or ink absorbing capability. The porosity of the porous support can be selected within the range of about 40 to 80%, preferably about 42 to 75%. If the porosity of the porous support is lower than 40%, due to the area of the absorption surface being small, its ink absorbing ability would become poor, while a porosity exceeding 80% may cause deterioration of the strength of the porous support itself.

Considering that the production of an image usually involves the insertion of the resulting recording material into an ink jet printer, the thickness of the porous support should be, for example, about 20 to 200 μm, preferably about 50 to 170 μm, and more preferably about 80 to 150 μm.

The porous support need only have, at least, a porous surface, and it may be a laminate composed of a sheet of paper or a plastic sheet as a substrate and a porous layer laminated thereon.

The porous support may further comprises conventional additives such as crosslinking agents, curing agents, antifoams, coatability improving agents, thickeners, lubricants, stabilizers (e.g., antioxidants, ultraviolet ray absorbers, heat stabilizers, light-resistant stabilizers), dyes, pigments, antistatic agents, antiblocking agents, fillers, gelling agents, and others.

[Organic acid]

The image-receiving sheet (imaging material) of the present invention contains an organic acid having a solubility in 100 g of water at 20° C. of about 0.01 to 2 g, preferably about 0.01 to 1.5 g. Incorporation of such organic acid improves the sharpness (print quality) of images.

In the case where the porous layer is constituted of the above-described porous support, the organic acid may be applied to at least one side of the support. Application of the organic acid onto the porous support not only improves the sharpness (print quality) of images but also results in the production of image-receiving materials of good texture.

Examples of the organic acid include aromatic polycarboxylic acids (e.g., C₈₋₁₂ aromatic polycarboxylic acids and acid anhydrides thereof such as phthalic acid, phthalic anhydride, isophthalic acid, terephthalic acid, trimellitic acid, and pyrromellitic acid), aromatic sulfonic acids (e.g., C₆₋₁₀ aromatic sulfonic acids such as benzenesulfonic acid, o-toluenesulfonic acid, m-toluenesulfonic acid, p-toluenesulfonic acid, naphthalene-β-sulfonic acid, and naphthalene-P-sulfonic acid), alicyclic polycarboxylic acids (e.g., C₈₋₁₀ alicyclic polycarboxylic acids such as 1,4-cyclohexanedicarboxylic acid and tetrahydrophthalic acid), heterocyclic polycarboxylic acids (e.g., pyridinecarboxylic acid, pyridinetricarboxylic acid, pyridinetetracarboxylic acid), and aliphatic polycarboxylic acids (e.g., C₂₋₁₀ aliphatic saturated polycarboxylic acids such as glutaric acid, adipic acid, suberic acid, and sebacic acid, C₄₋₆ aliphatic unsaturated polycarboxylic acids such as itaconic acid). Of these organic acids, aromatic polycarboxylic acids, particularly aromatic dicarboxylic acids (e.g., phthalic acids such as phthalic acid, phthalic anhydride and isophthalic acid, and derivatives thereof, particularly phthalic acid) are preferred.

The organic acid can be used in the form of a salt, and part of or the whole carboxyl group or sulfonic acid group of the organic acid may form a salt with a base. Organic acid salts include salts with inorganic bases (e.g., ammonium, alkaline metals such as potassium and sodium) and salts with organic bases (e.g., tertiary amine).

The organic acid may be incorporated into the porous layer, or it may be applied at least on the surface of the porous layer. When the porous layer contains the organic acid, the organic acid content is, relative to 100 parts by weight of the hydrophilic polymer, about 1 to 100 parts by weight (e.g., 2 to 100 parts by weight), preferably about 5 to 50 parts by weight, more preferably about 10 to 30 parts by weight.

In the case where the organic acid is applied onto the surface of the porous layer (e.g., porous supports such as non-woven cloth), its amount after having been dried may be about 0.05 g/m or more (e.g., 0.05 to 1 g/m²), preferably about 0.1 g/m or more (e.g., 0.1 to 1 g/m²), more preferably about 0.2 to 0.8 g/m².

The organic acid may be used along with conventional additives such as dye-fixing agents, stabilizers (e.g., antioxidants, ultraviolet ray absorbers, heat stabilizers, light-resistant stabilizers), binders (e.g., particularly, water-insoluble hydrophilic resins such as cellulose esters, polyester, acrylic resins, polyamide, polysulfone, polyamide, and polyuretane), coloring agents, antistatic agents, antifoams, coatability improving agents, thickeners, lubricants, dyes, pigments, antiblocking agents, fillers, and gelling agents.

[Production Process]

The image-receiving sheet of the present invention is fabricated by having a porous layer of an image-receiving sheet material contain the organic acid described above. For example, incorporation of the organic acid into the porous layer can be done through a process in which the porous layer is formed using a dope containing the organic acid, or a process in which the organic acid is applied onto the porous layer.

The process in which the porous layer is formed using a dope containing the organic acid is useful for the fabrication of an image-receiving sheet being a laminate composed of a substrate and a porous layer.

The organic acid is applied onto the porous layer by, for example, coating a coating agent a containing the organic acid on at least one side of the porous layer (the porous layer of a laminate, or the porous support) and drying, or by immersing the porous layer in the coating agent followed by drying.

The porous layer of the laminate can be fabricated by a phase separation process in which a polymer is microphase-separated using good and poor solvents, a foaming process in which a polymer is foamed, a stretching process in which a polymer film is stretched, a radiation process in which a polymer film is exposed to radiation thereby to make pores, an extraction process in which from a film made from a polymer or inorganic salt soluble in a solvent and a polymer insoluble in the solvent is extracted the component soluble in the solvent to make pores, a sintering process in which polymer particles are partially fused or fixed with a binder to utilize the gaps between the particles as pores, or by other processes.

Of these processes, the phase separation process in which a polymer is microphase-separated using good and poor solvents is preferably employed, and the microphase separation process includes a dry phase conversion method (a method in which a dope, mainly composed of a polymer, a good solvent for the polymer, and a poor solvent for the polymer having a boiling point higher than that of the good solvent, is coated on a substrate and dried to give a porous layer) and a wet phase conversion method (a method in which a dope, containing at least the polymer mentioned above and a good solvent therefor, is cast on or coated on a substrate and the resulting substrate is immersed in a poor solvent for the polymer thereby to cause phase separation and form a porous layer). The dry phase conversion method is particularly preferably employed due to its being suitable for mass production.

Further details of the production process in accordance with the dry phase conversion process are as described below. A dope, composed of a polymer, a good solvent therefore, and a poor solvent having a higher boiling point higher than that of the good solvent, is coated on a substrate. Upon drying, the good solvent of which the boiling point is low is evaporated prior to the poor solvent. At that time, as the evaporation of the good solvent proceeds, the solubility of the polymer is degraded and the polymer forms micells and is separated from the poor solvent phase. Further, as the evaporation of the poor solvent proceeds, the micells are brought into contact with each other to form a network or web structure, and upon completion of the evaporation of the poor solvent, a porous layer is formed.

The good solvent is selected according to the kind of the polymer. Examples of the good solvent are ketones (e.g., C₃₋₆ dialkyl ketones such as acetone, methyl ethyl ketone, methyl propyl ketone, methyl butyl ketone, and methyl isobutyl ketone; cyclohexanone), esters (e.g., C₁₋₄alkyl formates such as ethyl formate, C₁₋₄ alkyl acetates such as methyl acetate, ethyl acetate, and butyl acetate; ethyl propionate, ethyl butyrate), ethers (e.g., cyclic or chain C₄₋₆ ethers such as 1,4-dioxane, tetrahydrofuran, tetrahydropyran, diethyl ether, diisopropyl ether, and dimethoxyethane), cellosolves (e.g., C₁₋₄ alkyl cellosolves such as methyl cellosolve, ethyl cellosolve, and butyl cellosolve), cellosolve acetates (e.g., C₁₋₄ alkyl cellosolve acetates such as methyl cellosolve acetate and ethyl cellosolve acetate), aromatic hydrocarbons (e.g., benzene, toluene, xylene), halogenated hydrocarbons (e.g., methylene chloride, ethylene chloride), amides (e.g., formamide, acetamide, N-methylformamide, N-methylacetamide, N,N-dimethylformamide, N,N-dimethylacetamide), sulfoxides (e.g., dimethylsulfoxide), nitriles (e.g., acetonitrile, propionitrile, butylonitrile, benzonitrile), organic acids (e.g., formic acid, acetic acid, propionic acid), organic acid anhydrides (e.g., maleic anhydride, acetic anhydride), and mixtures thereof. Incidentally, the good solvent [e.g., lower alcohols (e.g., C₁₋₄ alkyl alcohols such as methanol, ethanol, isopropanol, and butanol; diacetone alcohol), cycloalkanols (e.g., C₄₋₈ cycloalkanols which may be substituted with a C₁₄ alkyl group, such as cyclopentanol, cylohexanol, methylcyclohexanol, dimethylcylohexanol)] is a poor solvent for some resins. The good solvent may contain a nitro compound (e.g., nitromethane, nitroethane, nitropropane).

More concretely, in the case of the use of cellulose acetate as the polymer, preferred as the good solvent are acetone, methyl ethyl ketone, ethyl acetate, dioxane, dimethoxyethane, methyl cellosolve, methyl cellosolve acetate, or mixtures thereof. Acetone is particularly preferred.

The term “poor solvent” means a solvent which shows no or low solubility in the polymer to be used, and there is no specific restriction as to what is used provided that its boiling point is higher than that of the good solvent. Examples of the poor solvent are water, esters (e.g., C₅₋₈ alkyl formates such as amyl formate and isoamyl formate; C₂₋₄ aliphatic carboxylic acid C₆₋₁₀ alkyl esters which may have a C₁₋₄ alkoxyl group such as amyl acetate, hexyl acetate, octyl acetate, 3-methoxybutyl acetate, 3-ethoxybutyl acetate, butyl propionate, and 3-methoxybutyl propionate; C₁₋₄ alkyl benzoates such as methyl benzoate, ethyl benzoate, and propyl benzoate), alcohols (e.g., C₆₋₁₀ alcohols such as amyl alcohol, heterocylic alcohol), aliphatic polyhydric alcohols (e.g., ethylene glycol, diethylene glycol, propylene glycol, polyethylene glycol, glycerol), and mixtures thereof.

More concretely, when cellulose acetate is used as the polymer, preferred as the poor solvent are amyl formate, cyclohexanol, methylcyclohexanol, ethyl benzoate, and mixtures thereof. Cyclohexanol is particularly preferred.

There is no particular restriction as to the proportions of the good solvent and the poor solvent in the dope provided that a homogeneous solution of the polymer is formed, and the proportions are suitably selected according to, for example, the porosity of the objective porous layer. Usually, the proportion of the poor solvent is selected within the range of, per 100 parts by weight of the good solvent, about 0 to 300 parts by weight, preferably about 3 to 250 parts by weight, more preferably about 5 to 250 parts by weight.

According to the degree of polymerization of the polymer, the polymer content of the dope is selected within the range of about 1 to 30% by weight, preferably about 1 to 25% by weight, particularly about 3 to 20% by weight (e.g., 3 to 15% by weight).

To the dope may be added conventional additives such as antifoams, coatability improving agents, thickeners, heat stabilizers, lubricants, ultraviolet ray absorbers, antistatic agents, and antiblocking agents unless the characteristics of the present invention are adversely affected.

The polymer, the good solvent, and the poor solvent are mixed in such a conventional manner as to add and dissolve the polymer in the good solvent and then add the poor solvent thereto and mix the resulting mixture by stirring.

There is no particular restriction as to the way of applying the porous layer applied to the substrate, and such a well-known method as roll coating, air knife coating, blade coating, rod coating, bar coating, or comma coating is adopted.

There is no particular restriction as to the way of drying the porous layer. When employing the dry phase conversion method, it is necessary that the temperature and steam pressure are such controlled that, firstly, the good solvent is evaporated to make the polymer into micells and then the poor solvent is evaporated so that the micells are brought into contact with each other, forming a network structure.

In the image-receiving sheet, the porous layer may be formed on only one side or either side of the substrate. The porous layer may be formed by coating the substrate with a dope containing a polymer and forming pores within the resulting layer in the film-forming step, or the substrate may be laminated with a porous layer separately prepared by, for example, dry phase conversion.

When a transparent substrate is employed for the fabrication of the image-receiving sheet, it is preferred that the substrate is transparent toward visible rays, and the light transmittance can be selected within the range of, at a wavelength of 400 nm, not less than 45% (i.e., 45 to 100%), preferably about 60 to 100% (e.g., 70 to 100%). According to the intended use, a non-transparent substrate may be employed.

In the application of the organic acid to the porous layer, the coating agent a containing the organic acid is coated in the same way as the porous layer is applied or by such a known technique as spray coating. The organic acid may be applied to the porous layer by immersion. There is no particular restriction as to the solvent for the coating agent and selection depends on the kind of the organic acid, or so. Examples of the solvent are alcohols (e.g., C₁₄ alkyl alcohols such as methanol, ethanol, isopropanol, and butanol), ketones (e.g., di-C₁₋₄ alkyl ketones such as acetone and methyl ethyl ketone), esters (e.g., C₁₋₄ alkyl formates such as ethyl formate), ethers (e.g., cyclic or chain C₄₋₆ ethers such as 1,4-dioxane and tetrahydrofuran), cellosolves (e.g., C₁₋₄ alkyl cellosolves such as methyl cellosolve and ethyl cellosolve), and aromatic hydrocarbons (e.g., benzene, toluene, xylene). These solvents can be used in mixture. Further, the solvent for the coating agent may contain water. The organic acid concentration of the coating agent is (organic acid/solvent (weight ratio)) about 0.1/99.9 to 10/90 (0.1/99.9 to 20/80), preferably about 1/99 to 10/90.

[Image-Receiving Sheet and Process for Forming Images]

So that the image-receiving sheet of the present invention is excellent in moisture absorption, it may be employed as an imaging material or image-receiving sheet for ink jet printing in which droplets of ink (e.g., pigment-type water-based inks, dye-type water-based inks) are ejected against the material. Although the image-receiving sheet of the present invention can be used indoors or outdoors, for outdoor use, pigment-type water-based inks are generally employed in view of durability.

Particularly, the image-receiving sheet constituted of the laminate described above produces images of good quality, for the inks received by the surface of the recording material is readily and assuredly absorbed into the porous layer and held therein, preventing the inks from staying on the surface and remaining sticky for a long period of time, which consequently result in inhibiting the inks from flowing or being mixed. Therefore, the image-receiving sheet constituted of the laminate described above is useful particularly for use as an OHP sheet or a sheet for high quality images which are required to be transparent or have a glossy surface.

The image-receiving sheet comprising the porous support described above is applicable to uses required of certain texture (softness), such as flags, banners, and shop curtains.

In the present invention, images are produced by recording the images or characters on the porous layer of the image-receiving sheet constituted of the laminate and then peeling the porous layer from the substrate. In the process of recording images of the present invention, the porous layer is separable from the substrate, and delamination of the porous layer from the substrate improves the images recorded on the porous layer in sharpness and color reproducibility, and transparency.

Production of an image may be carried out by recording the image or characters on the porous layer of the image-receiving sheet, laminating the porous layer with a covering sheet, and separating both from the substrate. The substrate film described above, particularly a transparent one can be employed as the covering sheet. In the image-recording process of the present invention, since the porous layer is separable from the substrate, smooth transfer of the porous layer can be expected. Particularly, a sheet with a small difference in adhesion strength between the imaged area and non-imaged area is excellent in ease of delamination. Moreover, use of the porous layer peeled from a substrate of relatively low water resistance along with a covering sheet (e.g., a covering sheet having a porous layer is adhered with the porous layer facing inward) makes the resulting image-receiving sheet suitable for outdoor uses that are required of high water resistance.

The present invention provides an image-receiving sheet for recording which is excellent in surface gloss, sharpness of recorded images, and color reproducibility as well as ink absorption and blocking resistance. Moreover, the present invention provides an image-receiving material which is excellent not only in ink absorption and blocking resistance but also in texture. Furthermore, according to the present invention, there can be obtained an image-receiving sheet which yields images excellent in water resistance and weatherability. The present invention further provides a image-receiving sheet having an appropriate adhesion strength between a porous layer and a substrate and thus excellent in separability (ease of delamination).

### EXAMPLES

The following examples are intended to describe this invention in further detail and should by no means be interpreted as defining the scope of the invention.

The term “part(s)” or “%” indicates the proportion by weight unless otherwise stated. The recording sheets obtained in Examples and Comparative Examples were evaluated for ink absorption, water resistance, image-definition (sharpness of images), blocking resistance, and adhesion strength according to the following methods.

[Ink Absorption]

Using an ink jet printer (Master Jet-JC2008, manufactured by Graphtech, Co. Ltd.), on the recording sheets obtained in Examples and Comparative Examples were individually printed solid images each in cyan, yellow, and magenta using the corresponding pigment-type water-based inks. After printing, a sheet of PPC copying paper was placed on the printed portion at timed intervals, and a load (250 g/cm²) was imposed on the paper for 10 seconds. Thereafter, the copying paper was peeled off and visually examined for the degree of offset, and the length of time taken by the copying paper to be free from offset was measured.

[Water Resistance-1]

On the recording (or imaging) sheets obtained in Examples and Comparative Examples were printed images in the same manner as in the ink absorption testing. Then, the printed portion was wiped with a sufficiently water-impregnated swab for three reciprocations at 25° C., and the degree of ink smear on the swab was evaluated according to the following criteria.

A: swab not smeared

B: swab slightly smeared with ink, the printed portion faded

D: complete removal of the coat in the wiped area

[Water Resistance-2]

On the recording sheets obtained in Examples and Comparative Example were printed images in the same manner as in the ink absorption testing. After having been immersed in water of ordinary temperature for 24 hours, the external appearance was visually examined according to the following criteria.

B: nothing occurred

C: printed portion slightly dissolved

D: most of the printed portion dissolved

[Sharpness of Images (Image-Definition)]

Using an ink jet printer (Master Jet-JC2008, manufactured by Graphtech, Co., Ltd.), on each of the recording (imaging) sheets obtained in Examples and Comparative Examples was printed a magenta line (100 μm width) on a yellow base, and its dots were observed under a microscope at a magnification of 50 folds and evaluated according to the following criteria.

A: little blurring of dots

B: slight blurring of dots, the actual size of each dot exceeding 120 μm

D: blurring of dots, the boundary between neighboring yellow and magenta dots being undiscerned

[Blocking Resistance]

At least two of the recording sheets obtained in Examples and Comparative Examples were piled up and allowed to stand for one day under a load of 40 g/cm² (3.92 mPa) at a temperature of 40° C. and a humidity of 90%RH. The blocking resistance was evaluated according to the following criteria.

A: no matting nor blocking

B: matting observed but no blocking

D: blocking

[Adhesion Strength]

Onto the porous layer of each of the recording sheets obtained in Examples and Comparative Examples was adhered an cellophane adhesive tape, and the sheet was cut into samples 15 mm in width. Using a tensile tester TENSILON UCT-5T by Orientech Co., Ltd., the adhesion strength was determined at a peel strength of 200 mm/min.

### Example 1

The following resin solution a was coated on one side of the a sheet of ink jet printing-adaptable PPC paper (manufactured by Kishu Seishi, K.K., FC dream) and dried at 70° C. for 5 minutes to give an 8 m-thick porous layer in which pores having a mean pore size of 1 μm were densely present. The evaluation results of the recording sheet obtained are shown in Table 1.

[Resin Solution a]

The resin solution a was prepared by adding 2 parts of phthalic acid and 100 parts of cyclohexanol to 100 parts of an acetone solution containing cellulose acetate (average acetylation degree: 55%, average polymerization degree: 170) at a concentration of 10%.

### Example 2

The following resin solution b was coated on one side of a sheet of Kent paper (manufactured by Tokushuseishi, K.K., White Excel Kent) and dried at a temperature of 70° C. and a humidity of 90%RH for 1.5 minutes and then at 120° C. for 3 minutes to give a 7 μm-thick porous layer in which pores having a mean pore size of 0.3 m were densely present. The evaluation results of the recording sheet obtained are shown in Table 1.

[Resin Solution b]

The resin solution b was prepared by adding 2 parts of phthalic acid and 15 parts of 3-methoxybutyl acetate to 100 parts of an N-,N-dimethylformamide solution containing acrylonitrile (AN)-vinylpyrrolidone (VP) copolymer (DUY, AN/VP=0.98/0.02 (molar ratio), manufactured by Daicel Chemical Industries, Ltd.) at a concentration of 10%.

### Example 3

The following resin solution c was coated on one side of a sheet of art paper (manufactured by Tokushuseishi, K.K., Npi dullart) and dried at a temperature of 60° C. and a humidity of 95%RH for 1.5 minutes and then at 120° C. for 3 minutes to give an 11 μm-thick porous layer in which pores having a mean pore size of 0.6 μm were densely present. The evaluation results of the recording sheet obtained are shown in Table 1.

[Resin Solution c]

The resin solution c was prepared by adding 1.2 parts of p-toluenesulfonic acid and 15 parts of 3-methoxybutyl acetate to 100 parts of an N,N-dimethylformamide solution containing polymethyl methacrylate (manufactured by Scientific Polymer Products) at a concentration of 10%.

### Comparative Example 1

An 18% aqueous solution of modified polyvinyl alcohol (manufactured by Nippon Gosei Kagaku, OKS-7158G) was coated on one side of a 100 μm-thick polyethylene terephthalate film (manufactured by Dupon Japan, Merinex 339) and dried at 120° C. for 5 minutes to provide a 15 μm-thick image-receiving layer. The evaluation results of the recording sheet obtained are shown in Table 1.

TABLE 1

| | | Water | Image- | | |
|---|---|---|---|---|---|
| | | resistance- | defini- | Blocking | Interlayer |
| | Ink absorption | 1 | tion | resistance | strength |
| Ex. 1 | 1 min. or less | A | A | A | 30 g/15 mm |
| Ex. 2 | 1 min. or less | A | A | A | 50 g/15 mm |
| Ex. 3 | 1 min. or less | A | A | A | 40 g/15 mm |
| Comp. | 3 minutes | D | B | D | — |
| Ex. 1 | | | | | |

### Example 4

After recording images on the recording sheet obtained in Example 1 in the same manner as in the ink absorption testing, the adhesion strength (Fp) was measured. The result is shown in Table 2 along with the adhesion strength (Fn) precedently measured. The images each in cyan, magenta, and yellow showed the same tendency, so that the data on the cyan-colored image were employed representatively (hereinafter, the same proviso unless otherwise indicated).

Then, the printed porous layer of the sheet was laminated with a surface-protecting sheet (manufactured by Sakurai K.K., LAG Protect G055AV50, adhesive applied-type). Thereafter, the surface-protecting sheet combined with the porous layer into one was peeled from the recording sheet. Upon peeling, the porous layer was cleanly separated from the substrate with almost no resistance. The result of the water resistance-2 testing is shown in Table 2.

### Example 5

After images had been printed on the recording sheet obtained in Example 2 in the same manner as in the ink absorption testing, the adhesion strength (Fp) was measured. The result is shown in Table 2 along with the adhesion strength (Fn) precedently measured.

Then, the printed porous layer of the sheet was laminated with a surface-protecting sheet (manufactured by Sakurai K.K., LAG Protect G055AV50, adhesive applied-type). Thereafter, the surface-protecting sheet combined with the porous layer into one was peeled from the recording sheet. Upon peeling, the porous layer was cleanly separated from the substrate with almost no resistance. The result of the water resistance-2 testing is shown in Table 2.

### Example 6

After images had been printed on the recording sheet obtained in Example 3 in the same manner as in the ink absorption testing, the adhesion strength (Fp) was measured. The result is shown in Table 2 along with the adhesion strength (Fn) precedently measured.

Then, the printed porous layer of the sheet was laminated with a surface-protecting sheet (manufactured by Sakurai K.K., LAG Protect G055AV50, adhesive applied-type). Thereafter, the surface-protecting sheet combined with the porous layer into one was peeled from the recording sheet. Upon peeling, the porous layer was cleanly separated from the substrate with almost no resistance. The result of the water resistance-2 testing is shown in Table 2.

TABLE 2

| | Fp/Fn/Fp-Fn (g/15 mm) | Water resistance-2 |
|---|---|---|
| Ex. 1 | 70/30/40 | D |
| Ex. 2 | 50/50/0 | D |
| Ex. 3 | 50/40/10 | D |
| Ex. 4 | 70/30/40 | B |
| Ex. 5 | 50/50/0 | B |
| Ex. 6 | 50/40/10 | B |

Table 2 shows the results of the water resistance-2 testing conducted for the recording sheets obtained in Examples 1 to 3. Compared to these recording sheets, those obtained in Examples 4 to 6 presented remarkably high water resistance. That is, the recording sheets obtained in Examples 4 to 6 have a sufficiently high water resistance to endure being used outdoors as materials for sign display.

### Comparative Example 2

A coating agent, composed of 100 parts of an aqueous solution containing modified polyvinyl alcohol (manufactured by Nippon Gosei Kagaku K.K., OKS-7158G) at a concentration of 15% and 1.5 parts of maleic acid, was coated on one side of a sheet of polyethylene terephthalate synthetic paper 100 μm in thick (manufactured by Toyo Boseki, K.K., Crysper) and dried at 120° C. for 5 minutes to provide a 15 μm-thick ink absorbing layer. Then, a dope, composed of 100 parts of an acetone solution containing cellulose acetate (average acetylation degree: 55%, average polymerization degree: 170) at a concentration of 10% and 100 parts of cyclohexanol, was coated thereon and dried for 3 minutes in an atmosphere of 80° C. and 90%RH to provide an 8 μm-thick porous layer in which pores having a mean pore size of 0.9 μm were densely present.

The measurement showed that the adhesion strength (Fn) between the porous layer and the ink absorbing layer was 70 g/15 mm.

The ink absorption of the recording sheet was evaluated, and the ink was found to dry within 1 minute. An attempt to laminate the porous layer with a protection film as in Example 4 resulted in cohesive failure of the porous layer, with the image printed thereon blemished. Therefore, it was impossible to measure the adhesion strength Fp. This is probably because that, after printing, the solvent for the pigment inks and the fluid of modified polyvinyl alcohol flowed into the porous layer, making no difference between the porous layer and the ink absorbing layer.

### Example 7

The following coating agent a was coated on one side of a 150 μm-thick polyester fabric (Metsuke: 92.3 g/m²) and dried at 80° C. for 5 minutes to provide an image-receiving material with 2.1 g of phthalic acid applied thereon per m (on a dried matter basis). The evaluation results of the image-receiving material are shown in Table 3.

### [Coating Agent a]

A coating agent a was prepared from 2 parts of phthalic acid and 98 parts of isopropanol as a solvent.

### Example 8

The coating agent a prepared above was coated on one side of a 100 μm-thick polyester non-woven fabric (manufactured by Hirose Seishi, K.K., 05-TH48, Metsuke: 46.0 g/m ) and dried at 80° C. for 5 minutes to provide an image-receiving material with 1.9 g of phthalic acid applied thereon per m² (on a dried matter basis). The evaluation results of the sheet are shown in Table 3.

### Example 9

The following resin solution b was coated on one side of the a sheet of ink jet printing-adaptable PPC paper (manufactured by Kishu Seishi, K.K., FC dream) and dried at 70° C. for 5 minutes to give a sheet provided with an 8 μm-thick plastic porous layer in which pores having a mean pore size of 1 μm were densely present. The plastic sheet was coated with the coating agent and dried at 80° C. for 5 minutes to provide an image-receiving material with 0.5 g of phthalic acid applied thereon per m on a dried matter basis. The evaluation results of the recording sheet are shown in Table 3.

[Resin Solution b]

The resin solution b was prepared by adding 100 parts of a cyclohexanol as a poor solvent to 100 parts of a 10% solution constituted of cellulose acetate as a cellulose derivative (degree of acetylation: 55, degree of polymerization: 170) and acetone as a good solvent.

### Comparative Example 3

The coating agent a was coated on one side of a 100 μm-thick polyethylene terephthalate film (manufactured by Dupon Japan Co., Merinex 339) and dried at 80° C. for 5 minutes to give an image-receiving material with 0.5 g of phthalic acid applied thereon per m on a dried matter basis. The evaluation results of the sheet are shown in Table 3.

### Comparative Example 4

An 18% aqueous solution of polyvinyl alcohol (manufactured by Nippon Gosei Kagaku, K.K., OKS7158G) was coated on the polyester fabric employed in Exmaple 7 and dried at 120° C. for 5 minutes to provide a 15 μm-thick image-receiving layer. The evaluation results of the material are shown in Table 3.

TABLE 3

| | | Water | Image- | Blocking |
|---|---|---|---|---|
| | Ink absorption | resistance-2 | definition | resistance |
| Ex. 7 | 1 min. or less | A | A | A |
| Ex. 8 | 1 min. or less | A | A | A |
| Ex. 9 | 1 min. or less | A | A | A |
| Comp. Ex. 3 | 3 min. or more | — | D | — |
| Comp. Ex. 4 | 3 min. or more | D | B | D |

The recording sheet of Comparative Example 3 did not absorb ink and thus no image was recorded thereon. The texture of the image-receiving materials of Examples after treatment was as it had been before. +

What is claimed is:

1. An image-receiving sheet comprising at least a porous layer, wherein the porous layer contains an organic acid having a solubility in 100 g of water at 20° C. of 0.01 to 2 g.

2. An image-receiving sheet according to claim 1, which comprises a laminate in which the porous layer is formed on at least one side of a substrate, or a porous support.

3. An image-receiving sheet according to claim 1, wherein the organic acid is an aromatic polycarboxylic acid.

4. An image-receiving sheet according to claim 1, wherein the mean pore size of the porous layer is 0.005 to 10 μm.

5. An image-receiving sheet according to claim 1, wherein the porous layer comprises a hydrophilic polymer and is provided on at least one side of a substrate.

6. An image-receiving sheet according to claim 5, which contains 1 to 100 parts by weight of the organic acid relative to 100 parts by weight of the hydrophilic polymer.

7. An image-receiving sheet according to claim 5, wherein the hydrophilic polymer is at least one member selected from the group consisting of a cellulose derivative, a vinyl-series polymer, and a polysulfone-series polymer.

8. An image-receiving sheet according to claim 1, wherein the porous layer has a microphase separation structure resulted from phase conversion.

9. An image-receiving sheet, which comprises a substrate and a porous layer formed on at least one side of the substrate, wherein the porous layer comprises least one member selected from the group consisting of a cellulose derivative, a vinyl-series polymer, and a polysulfone-series polymer and has a microphase separation structure resulted from phase conversion and contains 2 to 100 parts by weight of an aromatic dicarboxylic acid relative to 100 parts by weight of the polymer.

10. An image-receiving sheet according to claim 5, wherein the porous layer is separable from the substrate.

11. An image-receiving sheet according to claim 5, wherein the adhesion strength between the porous layer and the substrate is 1 to 500 g/15 mm.

12. An image-receiving sheet according to claim 5, which satisfies the following formula (1):

|Fp−Fn|<150 g/15 mm (1)
wherein Fn is the adhesion strength between the porous layer and the substrate in the non-imaged area, and Fp is the adhesion strength between the porous layer and the substrate in the imaged area.

13. An image-receiving sheet according to claim 1, wherein the porous layer is constituted of a porous support and at least one side of the porous support contains the organic acid.

14. An image-receiving sheet according to claim 1, wherein the amount of the organic acid is not less than 0.05 g/m² on a dried matter basis.

15. An image-receiving sheet according to claim 13, wherein the porous support is a porous plastic sheet or a fabric.

16. An image-receiving sheet according to claim 15, wherein the fabric is a woven or non-woven fabric.

17. An image-receiving sheet, wherein at least one side of a woven or non-woven polyester fabric contains an aromatic dicarboxylic acid in an amount of 0.05 to 1 g/m² on a dried matter basis.

18. A process for producing an image-receiving sheet comprising at least a porous layer, which comprises incorporating an organic acid to the porous layer of an image-receiving sheet, wherein the solubility of the organic acid in 100 g of water at 20° C. is 0.01 to 2 g.

19. A process according to claim 18, which comprises applying a dope, containing a hydrophilic polymer, good and poor solvents for the hydrophilic polymer, and an organic acid having a solubility in 100 g of water at 20° C. of 0.01 to 2 g, to at least one side of a substrate, and forming the porous layer by phase conversion.

20. A process according to claim 18, which comprises, after applying a dope containing a hydrophilic polymer and good and poor solvents for the hydrophilic polymer to at least one side of the substrate, forming the porous layer by phase conversion of the dope, applying a coating agent containing the organic acid having a solubility in 100 g of water at 20° C. of 0.01 to 2 g thereon, and removing a solvent of the coating agent.

21. A process according to claim 18, which comprises applying the organic acid having a solubility in 100 g of water at 20° C. of 0.01 to 2 g to at least one side of a porous support.

22. A process according to claim 21, wherein the organic acid is applied to the porous support by applying a coating agent containing the organic acid or immersing the porous support in the coating agent.

23. A process for forming an image, which comprises forming an image on a porous layer of an image-receiving sheet recited in claim 5 and separating the porous layer from a substrate.

24. A process for forming an image, which comprises forming an image on a porous layer of an image-receiving sheet recited in claim 5, laminating a covering sheet on the porous sheet, and separating the covering sheet and the porous layer from a substrate.

25. A process according to claim 23 or 24, wherein the image is recorded in a water-based ink.
